(19) United States
(12) Patent Application Publication
(10) Pub. No.: US 2002/0153022 A1
(43) Pub. Date: Oct. 24, 2002

(54) Method for preventing particles in a pre-clean chamber

(76) Inventors: Chia-ming Kuo, Hsin-chu (TW); Chao-Yuan Huang, Hsin-chu (TW)

Correspondence Address: BIRCH STEWART KOLASCH & BIRCH, PO BOX 747, FALLS CHURCH, VA, 22040-0747, US

(21) Appl. No.: 09/837,167

(22) Filed: Apr. 19, 2001

(51) Int. Cl. B08B 7/04; B08B 9/00

(52) U.S. Cl. 134/1.1; 134/1.2; 134/902

(57) ABSTRACT

A method for preventing particles in a pre-clean chamber includes a silica material supplying step and a silica sputtering step. With this method, impacting plasma onto a silica material dislodges silica. The dislodged silica is allowed to deposit on a layer of silicon-rich oxide on the bell-jar in the pre-clean chamber to prevent the silicon-rich oxide from peeling quickly so as to extend the life of the bell-jar.

### BACKGROUND OF THE INVENTION

A. Field of the Invention

The invention relates to a method for preventing particles in a pre-clean chamber and, more particularly, to a method for preventing particles in a pre-clean chamber of a physical vapor deposition (PVD) device.

B. Description of the Related Art

In a conventional semi-conductor manufacturing procedure, a PVD device is used to execute a metallic film plating procedure. As shown in FIG. 1, a conventional PVD device includes a buffer chamber 1, a pre-clean chamber 2, a transfer chamber 3, a process chamber 4 and a robot arm 5. The pre-clean chamber 2 is employed to execute a wafer pre-cleaning procedure. As shown in FIG. 2, the pre-clean chamber 2 includes a radio frequency (RF) generator 21, a bell-jar 22, a shield 23, and a pre-clean chamber body 24. When the pre-cleaning of a wafer 6 is going to be executed, the wafer 6 is transferred into the pre-clean chamber 2 by the robot arm 5. Then, a gas such as argon is induced into the pre-clean chamber 2, which is then ionized into plasma using the RF wave from the RF generator 21. By impacting the plasma onto the wafer 6, etching removes chemical residue remaining on the wafer 6 surface. It also removes the thin layer of oxide which is formed when the wafer 6 is exposed to atmosphere.

When the plasma impacting method completes the pre-cleaning of the wafer 6, The removal material further adhere to the bell-jar 22 and the shield 23. In this case, if the metallic film deposition procedure to be executed in the PVD device is an pre-metallic deposition procedure like Cobalt deposition process, the essential surface ingredient of the wafer 6 to be pre-cleaned in the pre-clean chamber 2 is silicon, as usual. Therefore, after multiple pre-cleaning procedures, a large amount of silicon-rich oxide will accumulate on the bell-jar 22 and the shield 23.

Since the bell-jar 22 is generally made of quartz and the adherent effect between the silicon-rich oxide and the quartz is poor, a peeling phenomenon occurs leading to particle contamination on the wafer 6 in the pre-clean chamber 6. Therefore, any subsequent metallic film manufacturing procedure will be inversely affected.

To resolve the above-mentioned problem, a manufacturer, usually, will clean the bell-jar 22 after a certain period of time to avoid the particle problem caused by the peeling of silicon-rich oxide from the bell-jar 22.

However, the manufacturing procedure must be suspended during the cleaning period and thus production efficiency is inversely affected. Therefore, it is an important objective to extend the life of the bell-jar 22 in the pre-clean chamber 2 so as to reduce time for maintenance and to promote production efficiency.

### SUMMARY OF THE INVENTION

In view of the above, an objective of the invention is to provide a method for preventing particles in a pre-clean chamber so as to extend the life of the bell-jar in the pre-clean chamber, to reduce the time required for maintenance, and thus to promote production efficiency.

The method for preventing particles in a pre-clean chamber according to the invention is featured by impacting plasma onto a silica material to dislodge silica. The dislodged silica is allowed to deposit on a layer of silicon-rich oxide already formed on the bell-jar so as to prevent the silicon-rich oxide from peeling quickly and accordingly to extend the life of the bell-jar.

To achieve the objective of the invention, a method for preventing particles in a pre-clean chamber according to the invention includes following steps:

providing a silica material in the pre-clean chamber; and

forming plasma in the pre-clean chamber and then impacting the plasma onto the silica material so as to sputter and deposit the silica dislodged from the silica material on the bell-jar in the pre-clean chamber.

The adherence effect between silica and the bell-jar is better than that between silicon-rich oxide and the bell-jar. Thus, when a layer of silicon-rich oxide is formed on the bell-jar, silica can be deposited on the layer of silicon-rich oxide on the bell-jar by impacting plasma onto the silica material. Therefore, the silicon-rich oxide is prevented from peeling quickly so as to extend the life of the bell-jar.

### BRIEF DESCRIPTION OF THE DRAWINGS

These and other objects and advantages of the invention will become apparent by reference to the following description and accompanying drawings wherein:

FIG. 1 is a schematic view showing the major parts of a conventional PVD device;

FIG. 2 is an exploded view showing the major parts a conventional pre-clean chamber; and

FIG. 3 is a schematic view showing the essential part of a PVD device employed in one embodiment of the method for preventing particles in a pre-clean chamber according to the invention.

### DETAIL DESCRIPTION OF THE INVENTION

Hereafter, a concrete embodiment of the invention will be described in detail.

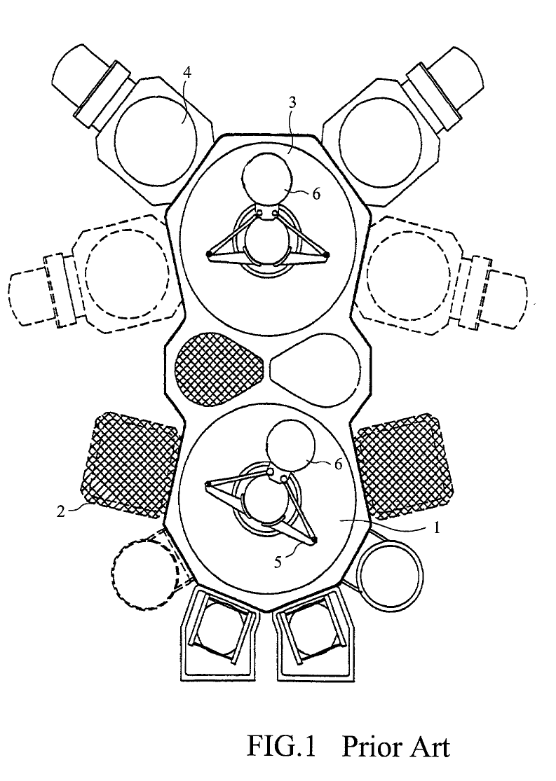

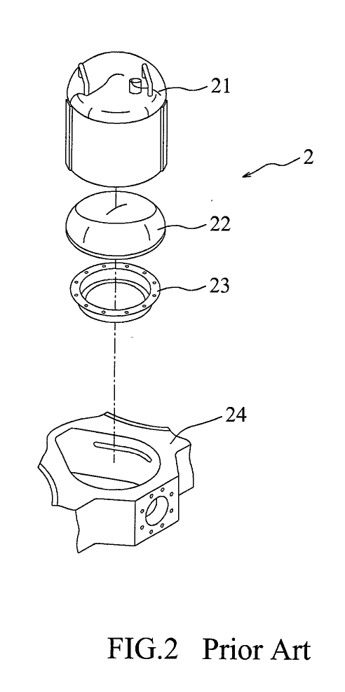

In order to conveniently describe the method and avoid redundant iteration, it should be previously pointed out that the reference numerals for illustrating the pre-clean chamber of a PVD device shown in FIG. 1 and FIG. 2 continue to be used in this embodiment.

The method for preventing particles in a pre-clean chamber according to the invention includes a silica material supplying step and a silica sputtering step. The method for preventing particles in a pre-clean chamber according to the invention is used when a layer of silicon-rich oxide with a certain thickness is formed on a bell-jar of a pre-clean chamber of a PVD device.

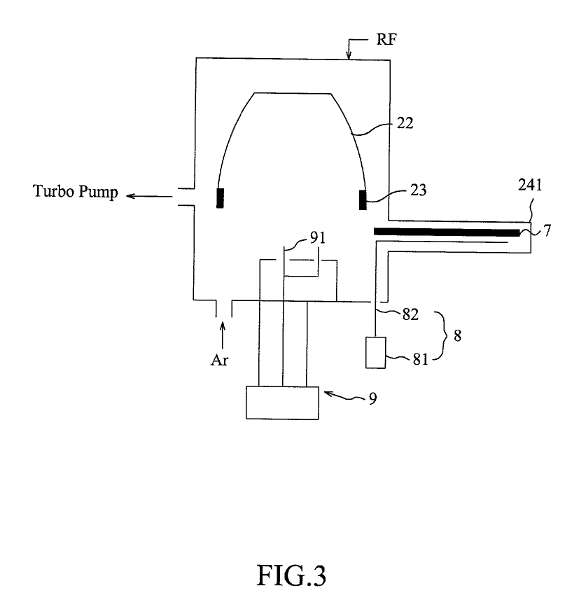

The silica material can be supplied by employing the PVD device shown in FIG. 3. With reference to FIG. 3, a pre-receiving chamber 241 capable of receiving a silica material 7 in advance is provided on the side wall of the pre-clean chamber body 24 of the PVD device. In this embodiment, the silica material 7 is of plate-like form. The plate-like silica material 7 can be positioned on a bracket 91 of a lift 9 through driving mechanism 8.

More particularly, the driving mechanism 8 includes a carrier portion 82 and a motive portion 81. When the motive portion 81 is activated, the carrier portion 82 will be rotated to shift the silica material 7 from the carrier portion 82 to the bracket 91 of the lift 9.

Afterward, the silica sputtering step is executed. In this step, argon gas is induced into the pre-clean chamber 2 and then is ionized into plasma by the RF generator 21 (FIG. 2). The resulting plasma will impact onto the silica material 7 to dislodge silica and the dislodged silica will sputter deposit on the bell-jar of the pre-clean chamber 2.

In addition to supplying the silica material 7 by the method associated with the device shown in FIG. 3, the silica material 7 can be mixed with the wafer 6 previously in a boat (not shown) and then be moved to the pre-clean chamber 2 by the robot arm 5.

Summarizing the above, the adherence effect between silica and the bell-jar is better than that between silicon-rich oxide and the bell-jar. Thus, when a layer of silicon-rich oxide is formed on the bell-jar, silica can be deposited on the layer of silicon-rich oxide on the bell-jar by impacting plasma onto the silica material. Therefore, the silicon-rich oxide is prevented from peeling quickly so as to extend the life of the bell-jar and to reduce the maintenance time. Production efficiency is thus promoted.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. A method for preventing particles in a pre-clean chamber, comprising
a silica material supplying step in which a silica material is provided in the pre-clean chamber; and
a silica sputtering step in which a plasma is formed in the pre-clean chamber to impact the silica material whereby silica is dislodged from the silica material to sputter in the pre-clean chamber.

2. The method for preventing particles in a pre-clean chamber as claimed in claim 1, wherein
the pre-clean chamber is a pre-clean chamber of a physical vapor deposition device.

3. The method for preventing particles in a pre-clean chamber as claimed in claim 1, wherein
the silica material is previously provided in the pre-clean chamber.

4. The method for preventing particles in a pre-clean chamber as claimed in claim 1, wherein
the plasma is produced by electrify the injected argon gas by radio-frequency.

5. The method for preventing particles in a pre-clean chamber as claimed in claim 1, wherein
the pre-clean chamber includes a bell-jar and the silica dislodged from the silica material is sputtered on the bell-jar.

6. The method for preventing particles in a pre-clean chamber as claimed in claim 1, wherein
the silica material is of plate-like form.
